(19) United States
(12) Patent Application Publication
(10) Pub. No.: US 2022/0076346 A1
(43) Pub. Date: Mar. 10, 2022

(54) METHOD AND SYSTEM FOR PROCESSING DATA TO CREATE INVESTMENT STRUCTURES

(71) Applicant: C. Squared IP Holdings, LLC, Scottsdale, AZ (US)

(72) Inventors: Scott Andrew SMITH, Ocala, FL (US); Christopher Graham SMITH, Aurora, CO (US)

(21) Appl. No.: 17/531,471

(22) Filed: Nov. 19, 2021

Related U.S. Application Data
(63) Continuation of application No. 15/836,453, filed on Dec. 8, 2017.
Application No. 15/836,453 is a continuation-in-part of application No. 15/377,814, filed on Dec. 13, 2016, now abandoned.
Application No. 15/377,814 is a continuation of application No. 13/888,212, filed on May 6, 2013, now abandoned.
Application No. 13/888,212 is a continuation of application No. 13/480,359, filed on May 24, 2012, now abandoned.
Application No. 13/480,359 is a continuation of application No. 13/480,335, filed on May 24, 2012, now abandoned.
Application No. 13/480,335 is a continuation of application No. 13/480,316, filed on May 24, 2012, now abandoned.
Application No. 13/480,359 is a continuation-in-part of application No. 12/013,292, filed on Jan. 11, 2008, now abandoned.
Application No. 13/480,335 is a continuation-in-part of application No. 12/013,292, filed on Jan. 11, 2008, now abandoned.
Application No. 13/480,316 is a continuation-in-part of application No. 12/013,292, filed on Jan. 11, 2008, now abandoned.
(60) Provisional application No. 60/884,533, filed on Jan. 11, 2007.
(60) Provisional application No. 61/489,642, filed on May 24, 2011.
(60) Provisional application No. 61/489,642, filed on May 24, 2011.
(60) Provisional application No. 61/489,642, filed on May 24, 2011.

(51) Int. Cl. G06Q 40/06

(52) U.S. Cl. CPC G06Q 40/06

(57) ABSTRACT

A method, apparatus, and system for processing data to create investment structures can include a simulation module configured to operatively receive a plurality of external economic condition parameters from a system database and a plurality of investment parameters from an investment criteria database. In addition, an investment selection module configured to process the simulation output in conjunction with the plurality of investment parameters is included. Further, an allocation module configured to process flagged one or more investment vehicles from the system database, a finance structure module configured to process the simulation output from the simulation module, and a unit evaluation module configured to process at least the optimal financing unit structure can also be included.

### RELATED APPLICATIONS

This application is a continuation of U.S. patent application Ser. No. 15/836,453, filed Dec. 8, 2017, which is a continuation-in-part of U.S. patent application Ser. No. 15/377,814, filed Dec. 13, 2016, which is a continuation of U.S. patent application Ser. No. 13/888,212, filed May 6, 2013, which is a continuation of U.S. patent application Ser. No. 13/480,359, filed May 24, 2012, Ser. No. 13/480,316, filed May 24, 2012, and Ser. No. 13/480,335, filed May 24, 2012, with each of U.S. patent application Ser. Nos. 13/480,359, 13/480,316 and 13/480,335 being a continuation-in-part of U.S. patent application Ser. No. 12/013,292, filed Jan. 11, 2008, which claims priority to and the benefit of U.S. Provisional Patent Application No. 60/884,533, filed Jan. 11, 2007. Each of U.S. patent application Ser. Nos. 13/480,359, 13/480,316, and 13/480,335 claim priority to and the benefit of U.S. Provisional Patent Application No. 61/489,642, filed May 24, 2011. The entire disclosure of each patent application referenced in this section is hereby fully incorporated herein by reference.

### BACKGROUND

A multitude of computing systems are needed to generate data that are used in financial markets. Typically these systems are of disparate platforms and functions. For instance, to determine proper allocation of investment monies, institutions and individuals face the daunting task of evaluating the voluminous data associated with an investment opportunity and determining a proper investment vehicle according to their risk/reward criteria. Equally, if not more daunting, is the process of creating investment vehicles that considers different risk tolerance levels of investors and concomitant returns.

By way of example, private equity (PE) funds pose a unique challenge with respect to factoring all relevant investment parameters to produce an appropriate fund. Such PE funds typically are known as forms of higher-risk, higher-return vehicles that invest capital within the funds in entities engaged in ventures that may include business creation, turn-around opportunities, and the growth of companies, as well as other assets. Some PE funds may borrow, or leverage, money to make further investments. Investments in PE funds are generally made by fund of funds, endowments, pensions funds, sovereign funds, insurance companies and high net worth individuals. Each category of investor typically has its own set of investment goals, investment preferences, and investment strategies. The PE fund provides working capital to a target company to nurture expansion, new product development, and/or restructuring of the company's operations, management, or ownership.

### SUMMARY

Therefore, there is a need for an approach for all the investment parameters/constraints through data processing and modeling to create a senior/subordinate system of assessing risk in an equity fund, where greater amounts of capital can be made available to the equity pool at a lower risk level. There is a further need to provide greater fund performance by leveraging capital call commitments.

According to one embodiment, a method comprises receiving, over a network connection, investment data associated with one or more investment vehicles. The method also comprises performing data analysis of the investment data according to a plurality of investment parameters. The method also comprises selecting, based on the analysis of the investment data, the one or more investment vehicles. The method also comprises designating the selected one or more investment vehicles as part of a portfolio of a private equity fund. The method also comprises computing a yield value representing future cash flow of the selected portfolio, wherein the prioritized units are associated correspondingly with one of or a combination of a plurality of rates of return, a plurality of risk tolerances, and a plurality of maturities, each of the rates of return being different from one another, each of the risk tolerances being different from one another, each of the maturities being different from one another. The method further comprises partitioning the yield value to allocate the future cash flow to the prioritized units according to the corresponding different rates of return, the corresponding different risk tolerances, and/or the corresponding different maturities.

According to another embodiment, an apparatus comprising at least one processor, and at least one memory including computer program code, the at least one memory and the computer program code configured to, with the at least one processor, cause the apparatus to receive, over a network connection, investment data associated with one or more investment vehicles. The apparatus is also caused to perform data analysis of the investment data according to a plurality of investment parameters. The apparatus is also caused to select, based on the analysis of the investment data, the one or more investment vehicles. The apparatus is also caused to designate the selected one or more investment vehicles as part of a portfolio of a private equity fund. The apparatus is also caused to compute a yield value representing future cash flow of the selected portfolio. Additionally, the apparatus is caused to create a pool financing structure specifying a plurality of prioritized units for the equity fund, wherein the prioritized units are associated correspondingly with one of or a combination of a plurality of rates of return, a plurality of risk tolerances, and a plurality of maturities, each of the rates of return being different from one another, each of the risk tolerances being different from one another, each of the maturities being different from one another. The apparatus is further caused to partition the yield value to allocate the future cash flow to the prioritized units according to the corresponding different rates of return, the corresponding different risk tolerances, and/or the corresponding different maturities.

According to another embodiment, a method comprises determining a summation of values of capital call commitments corresponding to a plurality of limited partners of a private equity fund. The method also comprises designating the summation of the values of the capital call commitments as a collateral value, and collecting investment parameters to select one or more securities. Additionally, the method comprises executing a simulation module, using the collected investment parameters, to generate a plurality of collateralized securities based on the collateral value, wherein the collateralized securities are backed by the capital call commitment and are to provide capital for the private equity fund. The collateralized securities are associated with one or more collateralized securities investors. The method further comprises allocating a cash flow distribution of the private equity fund to the one or more collateralized securities investors.

According to another embodiment, an apparatus comprising at least one processor, and at least one memory including computer program code, the at least one memory and the computer program code configured to, with the at least one processor, cause the apparatus to determine a summation of values of capital call commitments corresponding to a plurality of limited partners of a private equity fund. The apparatus is also caused to designate the summation of the values of the capital call commitments as a collateral value, and collect investment parameters to select one or more securities. Further, the apparatus is caused to execute a simulation module, using the collected investment parameters, to generate a plurality of collateralized securities based on the collateral value, wherein the collateralized securities are backed by the capital call commitment and are to provide capital for the private equity fund. The collateralized securities are associated with one or more collateralized securities investors. Further, the apparatus is caused to allocate a cash flow distribution of the private equity fund to the one or more collateralized securities investors.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of creating a pool financing structure based on data analysis of investment data, according to one embodiment;

FIG. 2 is a diagram of the components of the pool financing structure platform of FIG. 1, according to one embodiment;

FIGS. 3A and 3B are flowcharts of a process for creating a pool financing structure that utilizes prioritized units for an equity fund, and a process for providing a reduced outlay investing (RoI) structure, respectively, according to various embodiments;

FIG. 4 is a diagram of a user interface utilized in the processes of FIG. 3, according to various embodiments;

FIG. 5 shows an example of a PE fund that may be determined and modeled as a fund by the system of FIG. 1;

FIGS. 6A-6D are diagrams of exemplary investment scenarios employing a private equity fund structure;

FIG. 7A shows an example of a risk/return allocation vehicle (rRAV) for structuring investment risk and associated cash flow distribution, according to one embodiment;

FIG. 7B shows the rRAV of FIG. 7A configured with multiple priority levels, where cash flow distributions are prioritized based upon the respective priority level;

FIG. 7C shows one or more investors (e.g., limited partners (LPs)) investing in more than one priority level of the rRAV of FIG. 7A;

FIG. 7D shows an example of different investment units associated with the rRAV of FIG. 7A;

FIG. 8 shows an example of two funds having cash flow distributions feeding into the rRAV of FIG. 7A;

FIG. 9A shows two examples of the rRAVs of FIG. 7A, each example having A units and B units, where cash flow distribution, shown as A unit payments and B unit payments, is fed into a third rRAV according to FIG. 7A;

FIG. 9B shows a third rRAV of FIG. 9A formed exclusively from cash flow distributions from the A units of the other two rRAVs of FIG. 9A;

FIG. 9C shows an example of an investment scenario where an LP receives cash flow distributions from two LP units of a first PE fund, and receives cash flow distributions from a LP unit of a second PE fund;

FIG. 10 shows an example of a system for implementing the rRAV of FIG. 7, in an embodiment.

FIG. 11 shows an RoI example where capital call commitments of one or more LPs are used as a collateral guarantee to issue a collateralized security to raise capital for a fund;

FIG. 12A shows an example of a combined use of an rRAV and RoI (implemented through a collateralized security) with a PE fund;

FIG. 12B shows the collateralized security of FIG. 12A structured as senior (A) and subordinate (B) classes, in an embodiment;

FIG. 13 is a diagram of hardware that can be used to implement an embodiment of the invention;

FIG. 14 is a diagram of a chip set that can be used to implement an embodiment of the invention; and

FIG. 15 is a diagram of a mobile station (e.g., handset) that can be used to implement an embodiment of the invention.

### DETAILED DESCRIPTION OF PREFERRED EMBODIMENTS

A method, apparatus, and system for processing data to create investment structures are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

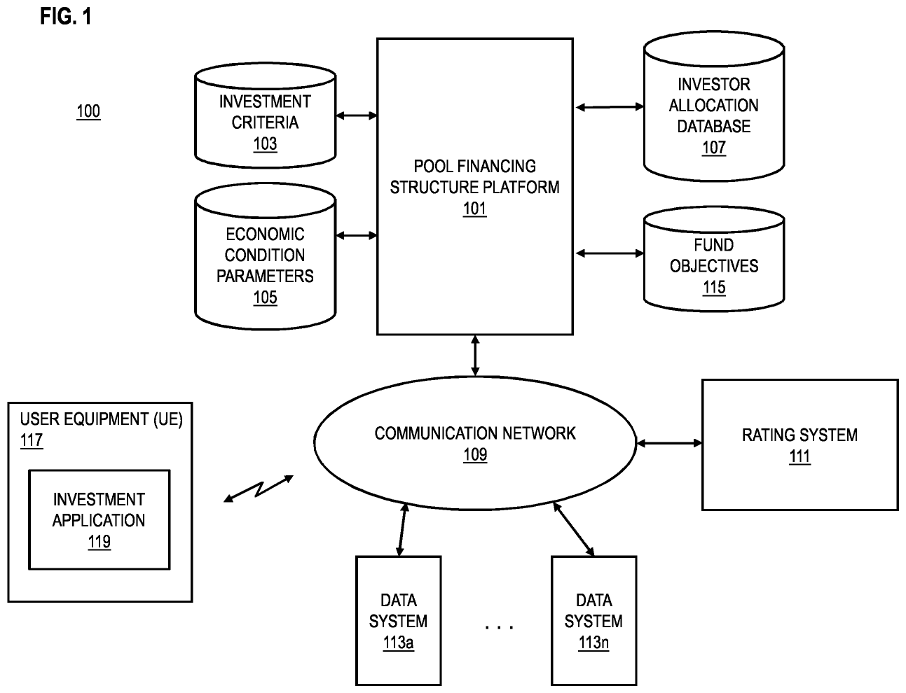

FIG. 1 is a diagram of a system capable of processing data to create investment structures, according to one embodiment. System 100 includes a pool financing structure platform 101 that can create investment vehicles using data from a variety of sources, in a dynamic manner, as economic and market conditions and investors' risk-return profiles continually change. By way of example, platform 101 can be applied to creation of a unique Private Equity (PE) fund that employs the following mechanisms, alone or in combination: (1) risk/return allocation vehicle (rRAV) that allocates future cash flow distributions according to different types of investment units with differing rate of returns; and (2) reduced outlay investing (ROI) that utilizes securities collateralized against capital commitments to provide greater leverage for financing the fund. By unique modeling and simulation, the platform 101 advantageously provides a greater pool of capital to a PE fund than would typically be available, lowers risk for the fund, as well as enhances the fund's performance.

PE funds include collective investment schemes used for making investments in various equity and debt securities. PE funds are typically organized as limited partnerships, limited liability companies, or limited liability partnerships. Investors who invest money into the PE funds are generally referred to herein as “Limited Partners” or “LPs,” but LPs may also be, and are sometimes referred to as, equity partners, equity investors, limiteds, or simply investors. LPs may be individual persons or entities, and typically include state and corporate pension funds, endowments, foundations, sovereign wealth funds, and private investors. The PE fund may have one or more general partners, referred to herein as “General Partners” or “GPs,” who invest and manage the capital contributed by the LPs. The GPs are sometimes also referred to as managing members, managing partners, managing directors, private equity sponsors, or in the case of venture capital, venture capitalists. For a typical PE fund, LPs contribute the majority, if not all, of the committed capital while GPs contribute little, if any, of the committed capital. As cash flow is realized from the PE fund's investments, the LP's invested principal capital is conventionally distributed back to the LPs in the same percentages as originally invested. Profits are conventionally distributed 20% to GPs and 80% to LPs, although sometimes LPs will receive certain priority distributions before GPs.

In a conventional PE fund, if a Limited Partner (LP) wants to reposition the LP's investment, due to changes in the LP's investment goals, for example, restructuring of the entire fund with cooperation of some or all of the other LPs and the General Partner (GP) is required, which, for all practical purposes, is not viable. The only option is for the LP to find a one-time purchaser in the secondary market, which will often produce a less than optimal outcome for the LP. Moreover, a senior/subordinate structuring cannot be adapted to the equity market because of the unpredictable yields from PE funds. PE funds do not typically have set maturity dates or regular repayment schedules for invested funds, and thus delinquency is not an issue on which risk may be assessed in the equity market. Such information, along with other relevant investment data, need to be collected and organized to produce a viable investment vehicle. This technical challenge is further exacerbated by the fact that such data reside across multiple sources, which include financial systems and non-financial systems.

To address this problem, a system 100 of FIG. 1 introduces the capability to collect and process investment data across multiple disparate platforms. Among other functions, pool financing structure platform 101 utilizes an investment criteria database 103 that captures a variety of investment criteria that should be satisfied to validate or qualify an investment vehicle that is created by platform 101. As shown, platform 101 also employ other data (e.g., economic condition parameters, other financially relevant information, etc.) that can be gathered from one or more external systems and stored locally for processing; in one embodiment, a database 105 stores economic condition parameters that are analyzed by platform 101. An investor allocation database 107 maintains information regarding investors and their roles/positions with regard to particular investment vehicles (or funds).

According to one embodiment, investment data associated with one or more investment vehicles is analyzed by platform 101, which then selects the one or more investment vehicles according to certain investment parameters. The selected investment vehicle(s) are designated to be part of a portfolio of a PE fund. Platform 101 computes the future cash flow of the portfolio. A pool financing structure is created and specifies a plurality of prioritized units for the equity fund. The prioritized units are associated correspondingly with a plurality of rates of return, risk tolerances, and/or maturities; each of the rates of return, risk tolerances, and/or maturities can be different from one another. Platform 101 allocates the future cash flow to the prioritized units according to the corresponding different rates of return, risk tolerances, and/or maturities.

As shown in FIG. 1, the system 100 comprises a pool financing structure platform 101 that is accessible via a communication network 109, which provides connectivity among rating system 111 and one or more data systems 113a-113n. The data systems 113a-113n can be controlled by one or more data providers, and provide information on various economic conditions that may be relevant in analyzing the investment vehicles. In one embodiment, the platform 101 receives such information and stores pertinent data within the economic condition parameters database 105, which may store any data that can impact investment decision making, including actuarial data relating to PE investments and climate data (as it relates to commodities), etc. Furthermore, database 115 can store the goals and objectives of the PE fund, and provide them to the pool financing structure platform 101 to output an appropriate fund to satisfy one or more of the goals within the fund's life.

By way of example, the communication network 109 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, cloud computing platform, or any other suitable packet-switched network, such as a commercially owned, proprietary packet-switched network, e.g., a proprietary cable or fiber-optic network. In addition, the wireless network may be, for example, a cellular network and may employ various technologies including global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The pool financing structure platform 101 can be accessed via a user equipment (UE) 117 via an investment application 119, which permits access and/or control of the platform 101 depending, for instance, on the role of the user and/or other security policies. The UE 117 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 117 can support any type of interface to the user (such as “wearable” circuitry, etc.).

By way of example, the UE 117 and pool financing structure platform 101 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

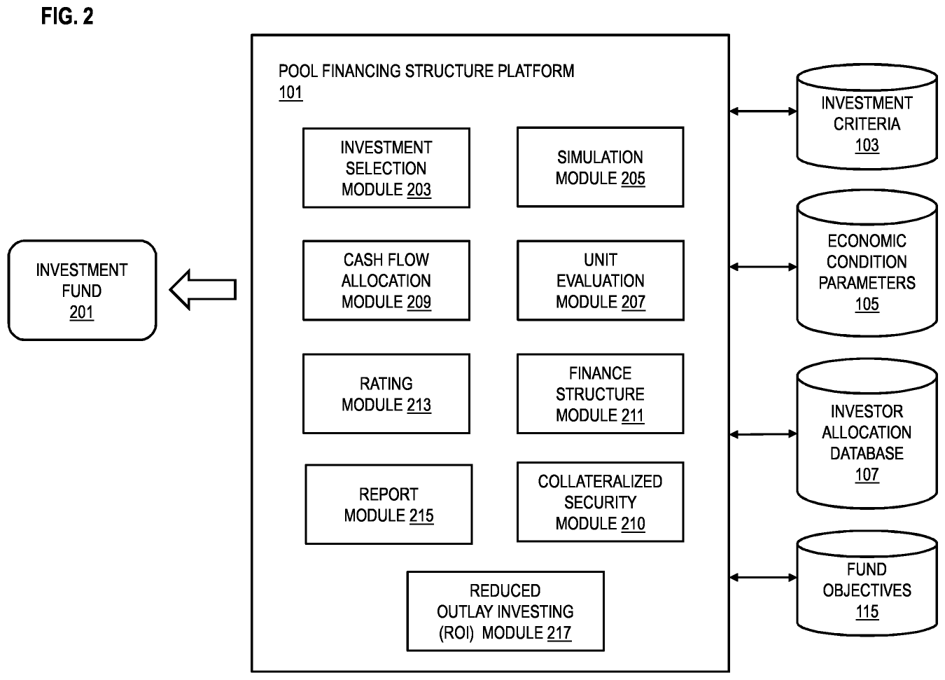

FIG. 2 is a diagram of the components of the pool financing structure platform 101 of FIG. 1, according to one embodiment. By way of example, the platform 101 includes one or more components for creating a pool financing structure that specifies multiple prioritized units for an investment fund 201, wherein the prioritized units are associated with a plurality of different rates of return. In one embodiment, the prioritized units can be further associated with different risk tolerances and/or different maturities. It is contemplated that the functions of these components may be combined in one or more components or performed by other components of equivalent functionality. In one embodiment, the pool financing structure platform 101 includes an investment selection module 203, which operates in conjunction with a simulation module 205, to select the investment vehicles that are to be included in the fund 201. For example, simulation module 205 receives economic data indicating economic conditions affecting the one or more investment vehicles, and conduct simulation of performance of the portfolio using the economic data to assist the investment selection module 203 with selection of the one or more investment vehicles. The simulation module 205 feeds the analysis data to a finance structure module 211 to determine an optimal fund financing structure, which may be modified over time based upon the performance of the portfolio and changing market conditions.

The platform 101 additionally utilizes a unit evaluation module 207 to determine the prioritized units, and a cash flow allocation module 209 to compute a yield value that represents cash flow for the created investment fund 201. A collateralized security module 210 provides and analyzes data relating to collateralized securities that may be used to raise capital for the PE. A rating module 213 is employed by platform 101 to seek appropriate investment rating of, for instance, the collateralized securities from rating system 111 (as shown in FIG. 1).

As shown, platform 101 may include a report module 215 that generates a report on the private equity fund based on the modeled potential fund rate. In one scenario, platform 101, via the rating module 213, generates a request for rating data about the private equity fund, wherein the request specifies the report. The rating module 213 receives rating data from the rating system 111 in response to the request. The rating data is used for the allocation of the future cash flows to the prioritized units.

The pool financing structure platform 101 can also track investors and their allocation of prioritized units using, for instance, investor allocation database 107. By way of example, platform 101 registers a first investor to receive one of the prioritized units, and registers a second investor to receive a second one of the prioritized units, etc. Moreover, platform 101 can generate a distribution report that includes identification information of the investors along with their financial data associated with the rate of return of the corresponding prioritized units. Optionally, the financial data can be further associated with risk tolerances and/or maturities of the prioritized units. The distribution report can transmitted to UE 117 over network 109 for display to the user; in this example, the user has the role of general partner in the private equity fund 201.

As shown, platform 101 can additionally include a reduced outlay investing (ROI) module 217 that assist with formulating a finance structure that permits obtaining financing against capital that has been committed by the investors. Accordingly, the outlay of capital by these investors are reduced, and their yield potentially increased.

According to certain embodiments, the platform 101 has the capability to create a PE fund that can produce yields for investors without actually calling any, or all, of the capital commitments made by the LPs. The modeling and simulation features of the platform 101, in advance or during operation, can determine how the PE fund may operate and invest based on the credit worthiness of the capital commitments of some or all of the LPs. Conventionally, a PE fund can only produce returns to LPs based on money actually advanced to the fund, i.e., called capital commitments, by the LPs. The platform 101, however, can produce a PE fund that yields returns based on only the amount of capital committed, without having to actually call the capital, and such a fund can be modeled and simulated to structure the PE fund such that respective amounts of called and uncalled capital can be balanced to create greater returns for the entire PE fund.

The platform 101 may model and simulate a PE fund to create a hybrid PE fund that may advantageously utilize both of the rRAV and RoI mechanisms together. That is, according to certain embodiments, a PE fund may be established to create senior and subordinate LP classes where seniority may be established based on the likelihood that an LP's committed capital will ever be called. By structuring the capital call commitments to assign shares of the PE fund (which can be assigned according to seniority, for instance), some investors would experience a lower return yield, but may not ever have their capital commitments called, whereas other investors expect to have their capital commitments called by the fund, but would also expect to experience a greater return yield thereby.

According to certain embodiments, greater pools of investment capital can be made available to the entire PE fund by investors with access to large amounts of capital to commit to the fund, but which may never have to be actually advanced to the fund. When such capital has a low risk of ever being called, the capital may advantageously realize simultaneous returns from both the PE fund itself, as well as conventional yields from remaining in the control of the investor.

PE funds enable investors to invest money alongside other investors in order to benefit from working as part of a group. PE funds are also promoted with a wide range of investment aims targeting specific geographic regions and/or specified industry sectors. Some PE funds are open-end or closed-end. Open-end funds may be divided into shares that vary in price in proportion to the variation in value of the fund. When money is invested, new shares or units are created to match the prevailing share price. When shares are redeemed, assets that are sold match the prevailing share price. In open-end funds, supply/demand is thus not created for shares, which reflect the underlying assets of the fund. Closed-end funds, on the other hand, issue a limited number of shares in an initial public offering (IPO) or through private placement. IPO shares can be traded on an exchange or directly through the fund manager to create a secondary market. Additional shares may then be offered after the IPO.

Common PE fund investment strategies include, but are not limited to, leveraged buyouts (LBO), venture capital, growth capital, distressed investments, and mezzanine capital. In a typical LBO transaction, a private equity firm buys majority control of an existing or mature firm. In a venture capital, or growth capital, investment, on the other hand, investors (typically venture capital firms or angel investors) may invest in young or emerging companies, and rarely obtain majority control.

Moreover, in certain embodiments, the platform 101 can split a PE fund into multiple classes of shares. Assets of each class can be pooled, and classes can differ in the fees and expenses paid out of the fund's assets. Some of such differences may reflect different costs involved in servicing investors or shares in the various classes.

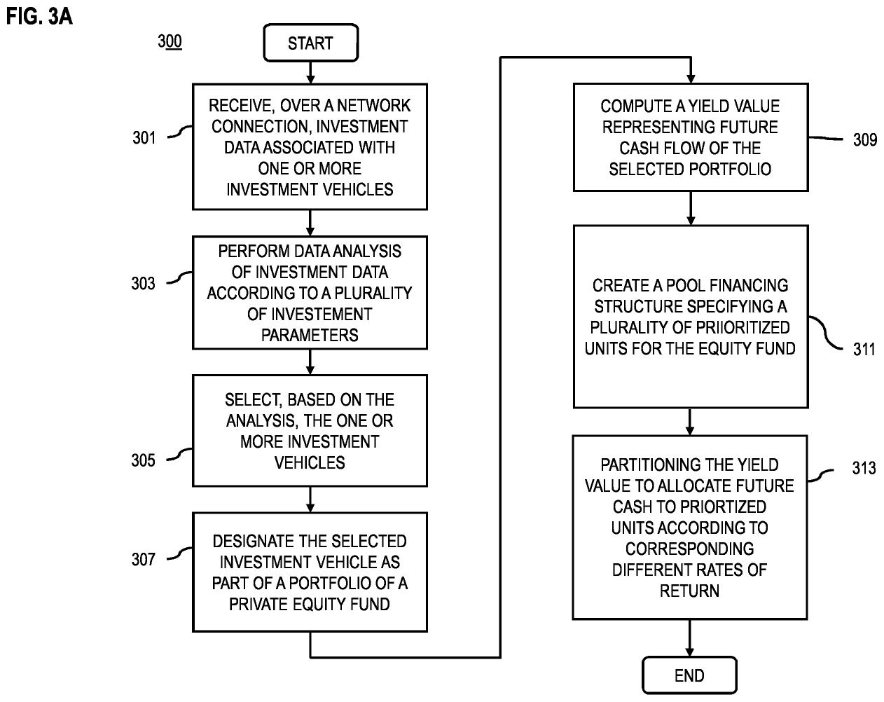

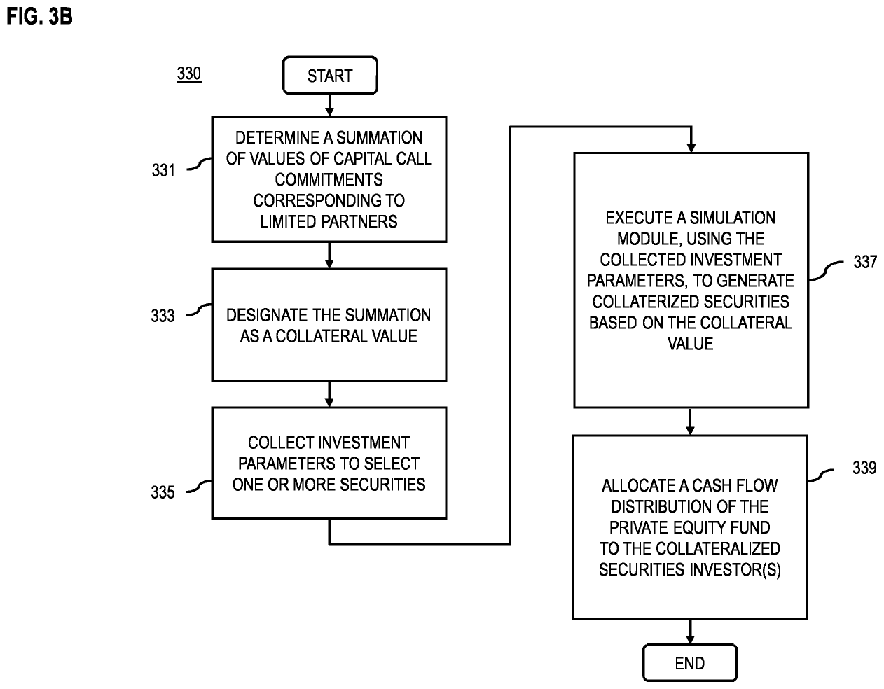

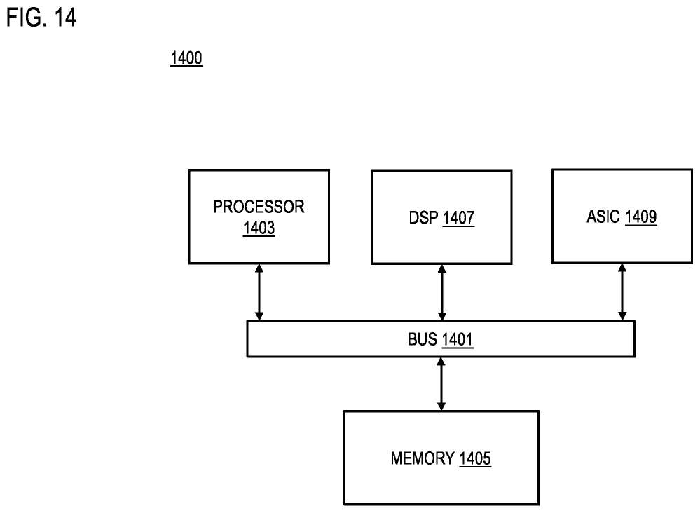

FIGS. 3A and 3B are flowcharts of a process for creating a pool financing structure that utilizes prioritized units for an equity fund, and a process for providing a reduced outlay investing (RoI) structure, respectively, according to various embodiments. In one embodiment, the investment selection module 203 (e.g., in conjunction with the simulation module 205, the unit evaluation module 207, and cash flow allocation module 209) performs the process 300 and is implemented in, for instance, a chip set including a processor and a memory as shown FIG. 14. In step 301, investment data associated with one or more investment vehicles are received over a network connection. Data analysis of the investment data is performed by, e.g., simulation module 205, according to a plurality of investment parameters obtained from the investment criteria database 103, per step 303. In step 305, the investment selection module 203 selects based on the analysis of the investment data, the one or more investment vehicles, and designates the selected one or more investment vehicles as part of a portfolio of fund 201 (as in step 307). Cash flow allocation module 209 then computes a yield value representing future cash flow of the selected portfolio, per step 309. In step 311, a pool financing structure is created, and specifies a plurality of prioritized units for the equity fund. According to one embodiment, the prioritized units are associated correspondingly with a plurality of rates of return, wherein each of the rates of return is different from one another. In step 313, the cash flow allocation module 209 partitions the yield value to allocate the future cash flow to the prioritized units according to the corresponding different rates of return.

In one embodiment, platform 101 models, e.g., via the finance structure module 211 in conjunction with the simulation module 205, a potential fund rate of return for the equity fund by computing Return on Investment on the Equity Raised (EQ_{RIO}) according to,

$$E {Q}_{RIO} = ( C {R}_{RIO} - COD 1 ( D 1 / C R ) - COD 2 ( D 2 / C R ) … CODn ( Dn / C R / C R - D 1 - D 2 … - Dn ) )$$

wherein CR_{RIO} is Return on Investment for Capital Raised (CR_{RIO}),
COD1, COD2, and CODn are Cost of Debt in each class of debt,
D1, D2, and Dn are principal amounts in each of the class of debt, and
CR is Capital Raised.

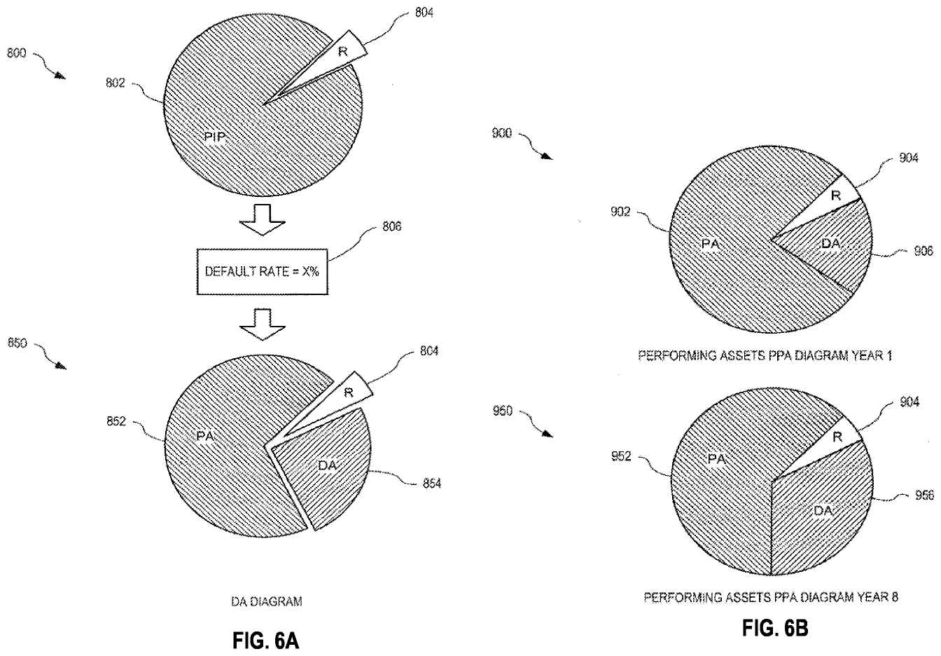

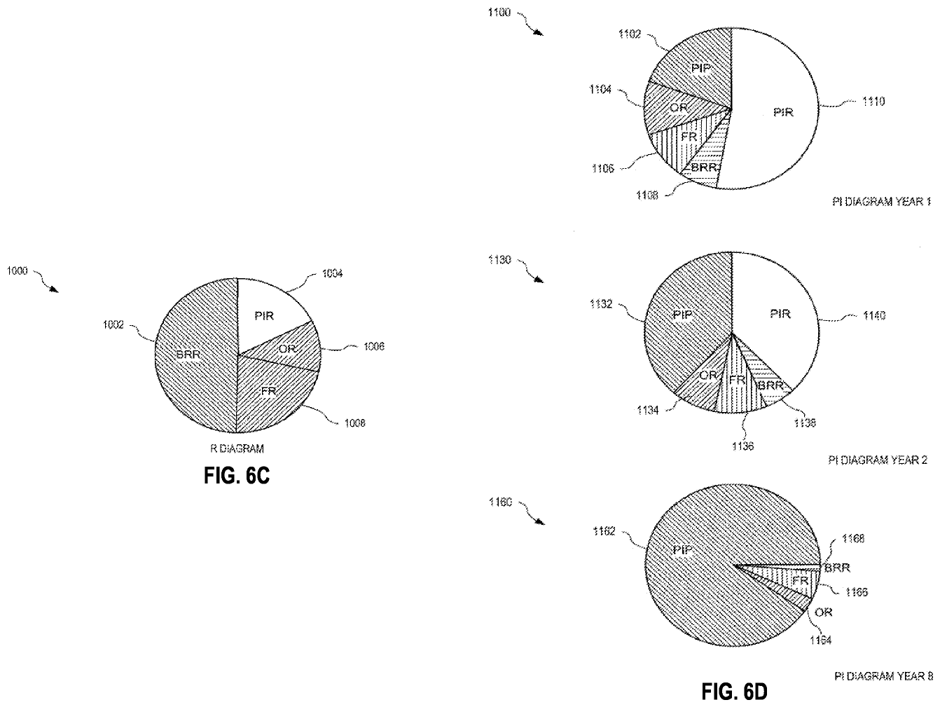

The above equation is further described below with respect to FIGS. 6A-6D.

In another embodiment, platform 101 models, e.g., via the finance structure module 211 in conjunction with the simulation module 205, a potential rate of return for a subordinate equity investment in a fund is “SEQ_{ROI}”. The formula is “SEQ_{ROI} equals the return from the overall portfolio, minus the total return, including principle, paid to first class of senior security over time, minus the total return, including principle, paid to the second class of senior security over time, etc., minus the total return, including principle, paid to nth class of senior security over time, minus any remaining expenses of the fund, including any fees and carried interest paid to the General Partners, divided by the amount advanced by the subordinate equity investment.” This can also be expressed as: SEQ_{ROI}=(P_{R}−C1SS_{R}−C2SS_{R}−CnSS_{R}−EX)/SEQ. By way of example, the SEQ_{ROI} for a subordinate equity investment in a fund in which a $1 million subordinate equity investment returns $10 million after repaying all the classes of senior securities and expenses of the fund, including any fees and carried interest paid to the General Partners is 10×. Here is a summary of the terms in the above formula: “P_{R}” is the return earned by the fund's portfolio, which would be the total receipts from the liquidation of the portfolio, less any selling expenses, “SEQ” is the amount of money invested in the fund by the subordinate equity, “EX” is the equity invested in the fund, “t” is the elapsed time in years until a return on the investment is realized, “C1SS_{R}” is the total return, including principle, paid to first class of senior security over time, “C2SS_{R}” is the total return, including principle, paid to second class of senior security over time, “CnSS_{R}” is the total return, including principle, paid to nth class of senior security over time.

The Annualized Return on Investment (AROI) for a subordinate equity investment in a fund is “SEQ_{AROI}”. The formula is SEQ_{AROI} equals the return from the overall portfolio, minus the total return, including principle, paid to first class of senior security over time, minus the total return, including principle, paid to the second class of senior security over time, etc., minus the total return, including principle, paid to nth class of senior security over time, minus any remaining expenses of the fund, including any fees and carried interest paid to the general partners, divided by the amount advanced by the subordinate equity investment times the duration of the investment in years. This can also be expressed as: SEQ_{AROI}=(P_{R}−C1SS_{R}−C2SS_{R}−CnSS_{R}−EX)/t(SEQ). By way of example, the SEQ_{AROI} for a subordinate equity investment in a fund in which a $1 million subordinate equity investment returns $10 million over 5 years after repaying all the classes of senior securities and expenses of the fund, including any fees and carried interest paid to the General Partners is 2×/year. The terms in the above formula are the same as defined previously.

The improvement in the Return on Investment for an equity investment in a fund if it is structured versus if it is not structured is “I_{ROI}”. This is expressed in the following formula: I_{ROI}=SEQ_{ROI}/EQ_{ROI}, where EQ_{ROI} is the Return on Investment for the equity in an unstructured fund. The expanded version of this formula is: I_{ROI}=((P_{R}−C1SS_{R}−C2SS_{R}−CnSS_{R}−EX)/SEQ)/((P_{R}−EX)/EQ), where “EQ” is the equity invested in an unstructured fund.

The improvement in the Annualized Return on Investment for an equity investment in a fund if it is structured versus if it is not structured is “I_{AROI}”. This is expressed in the following formula: I_{AROI}=SEQ_{AROI}/EQ_{AROI}, where EQ_{AROI} is the Annualized Return on Investment for the equity in an unstructured fund. The expanded version of this formula is: I_{AROI}=((P_{R}−C1SS_{-C}2SS_{R}−CnSS_{R}−EX)/t(SEQ))/((P_{R}−EX)/t(EQ)).

As shown in FIG. 3B, the platform 101 can also reduce capital outlay by the limited partners through a Reduced Outlay Investing (RoI) mechanism using process 330. This RoI mechanism, in one embodiment, can be utilized with the process of FIG. 3A or independently. In step 331, the platform 101 determines a summation of values of capital call commitments corresponding to multiple limited partners of a private equity fund. The summation of the values of the capital call commitments is then designated as a collateral value, per step 333. The platform, as in step 335, collects investment parameters to select one or more securities. Per step 337, the platform 101 executes simulation module 205 (shown in FIG. 2), using the collected investment parameters, to generate a plurality of collateralized securities based on the collateral value. Under this scenario, the collateralized securities are backed by the capital call commitment and are to provide capital for the private equity fund. Depending on the application, the collateralized securities are associated with one or more collateralized securities investors. In step 339, the platform 101 allocates a cash flow distribution of the private equity fund to the one or more collateralized securities investors. In one embodiment, the platform 101 can account for any shortfall associated with this method. For instance, the platform 101 can compute a shortfall value corresponding to the collateralized securities, wherein the shortfall value is to be covered by the limited partners.

If, however, the platform 101 determines that an excess of capital results, the platform 101 then determines an excess value associated with the cash flow distribution; the excess value is greater than a commitment value representing commitment to the one or more collateralized security investors. The platform 101 accumulates the excess value for designation in satisfying future commitments to the one or more collateralized security investors. The assets of the private equity fund are assigned to the limited partners in lieu of payment of the cash flow distribution to one or more of the limited partners.

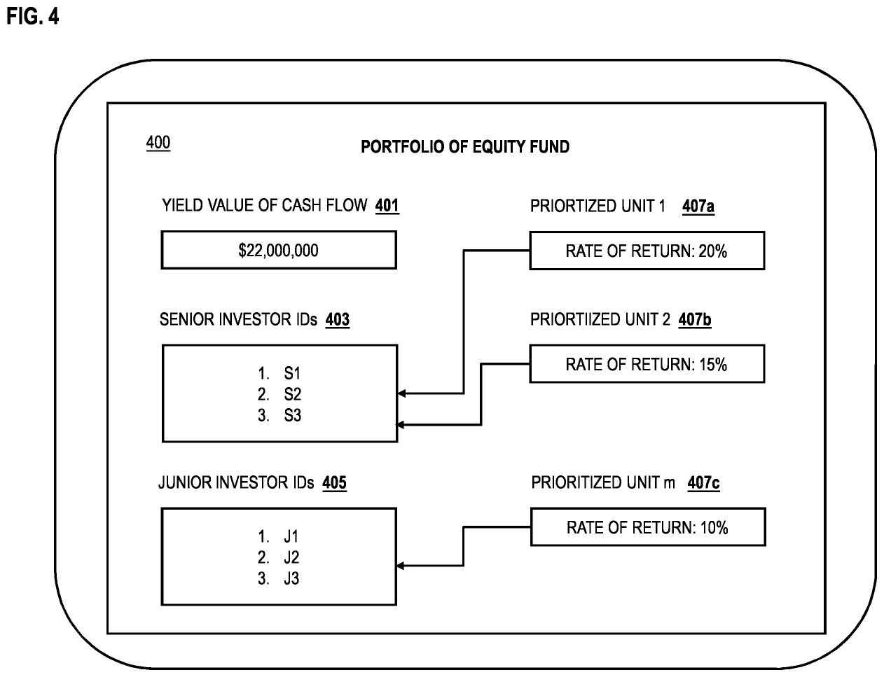

FIG. 4 is a diagram of a user interface utilized in the processes of FIG. 3, according to various embodiments. UE 117 executes the investment application 119, which provides a graphical user interface (GUI) 400 to platform 101. The GUI 400 can include a screen that permits a view of the different investors and their prioritized units for the fund 201. In this example, the GUI 400 provides for an area 401 for displaying the yield value of the cash flow of the fund 201. Additionally, section 403 provides a list of senior investor identifiers (IDs); similarly, section 405 provides IDs for junior investors. The IDs may be any unique identification means, which may be actual names or any unique set of characters. Also, application 119 can mask the identity of the investor for security purposes; that is, the schema for specifying the characters can arranged to have the investors be anonymous to the user of the application 119 (assuming the user does not have the credentials or authority to view the names). As shown, multiple prioritized units within sections 407a-407c can be shown with the corresponding rates of return. In this example, the senior investors can be associated with one or more prioritized units 407a and 407b, which provide higher returns than that of the junior investor's units 407c.

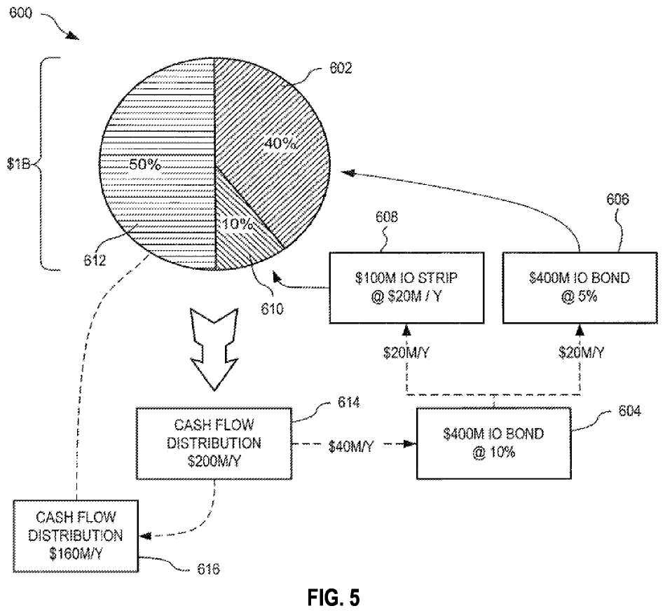

FIG. 5 shows an example of a PE fund that may be determined and modeled as a fund by the system of FIG. 1. In this example, a large fund, e.g., $1 billion fund 600, may be structured and modeled as a fund by the simulation module (i.e., simulator) 205 of platform 101. Modeling of fund 600 by simulator 205 can determine that fund 600 be structured to generate, for instance, 40% of its equity 602 from an interest-only (10) primary bond 604 of $400 million that has a coupon rate of 10%. Primary bond 604 thus costs $40M per year. Where the coupon rate (i.e., 10%) of primary bond 604 is greater than the average market coupon rate, a secondary bond 606 may be issued for $400M with an average market rate coupon rate of 5%, thus costing $20M per year. Since the primary bond is earning $40M per year, there is $20M per year remaining. Thus, in this example, an IO strip bond 608 is issued for the remaining $20M per year with a present value (PV) of $100M, thereby adding 10% equity 610 to fund 600. Thus, only 50% equity 612 of fund 600 need be raised from subordinate investors (i.e., LPs). These parameters are calculated and analyzed by investment selection module 203 in conjunction with simulation module 205 as well as finance structure module 211, according to one embodiment.

In summary, the yield from primary bond 604 that yields 10% ($40M per year) is paid into a fund that pays (a) secondary bond 606 yielding 5% ($20M per year) and (b) IO strip bond 608 for $20M per year. Secondary bond 606 is sold for face value, generating $400 million for equity 602, and the rights to the income stream ($20M per year) for IO strip bond 608 is sold to generate $100M for equity 610. Thus, the amount of equity necessary (i.e., LP equity 610) to fully capitalize fund 600 is reduced from $600M to $500M, as determined by the collateralized security module 203.

In this example, the annual cash flow distribution 614 on fund 600 is $200 million; this is determined by the cash flow allocation module 209. Therefore, after paying $40M per year as cost of primary bond 604 (i.e., the debt service on $400M), $160M per year is available as a cash flow distribution 616 on the $500M of equity 612, representing an annual rate of return to the LPs of 32%.

In order to ensure that the buyer of IO strip bond 608 does not lose the principal investment in the event of a prepayment of primary bond 604, simulator 205 may determine that a declining prepayment penalty is required for primary bond 604. In the example of FIG. 5, the penalty may be calculated to be about $100 million for a prepayment of primary bond 604 on day one, declining to zero dollars on the final day of maturity of IO strip bond 608 (i.e., after 10 years in this example).

One challenge in securitizing PE funds occurs with the uncertainty in projecting returns for the fund. However, actuarial data relating to PE investments can be collected and stored by economic condition parameters database 105; such data can cover a wide range of economic cycles. In addition, scheduling the returns on PE investments in a way that will better meet the strict requirements of payments due investment grade securities can be accomplished through either the use of a) funded reserves, and/or b) accrued interest bonds (e.g., zero coupon bonds), and/or through the use of preference rates. Because the return of an investment fund is proportional to the percentage of fund capital invested in assets versus the percentage of the fund held in reserve, repayment schedules that defer payments until after the assets have had sufficient time to produce a return may be preferable over schedules requiring interest payments early in the life of the fund.

FIGS. 6A-6D are diagrams of exemplary investment scenarios involving a private equity fund. By way of example, FIG. 6A shows principal 802 invested in assets that become defaulted between year one 800 and year eight 850, and a portion 804 that has been set aside as reserve. Principal 802 is referred to herein below as Principal Invested in the Portfolio (“PIP”) 802, and portion 804 is referred to herein below as total Reserve (“R”) 804. FIG. 6B shows the expected increase in the ratio of defaulted assets to principal invested between year one 900 and year eight 950; FIG. 6C shows a total Reserve (“R”) 1000 of the fund broken into component parts and described in detail below; and FIG. 6D shows expected changes to components of year one total Reserve (“R”) 1100, year two total Reserve (“R”) 1130 and year eight total Reserve (“R”) 1160. These investment scenarios are analyzed and processed by the pool financing structure platform 101; namely, the finance structure module 211, investment selection module 203, the unit evaluation module 207, and the simulation module 205.

It is noted that not all of the capital raised by PE funds is intended for immediate investment. For example, assets are identified and evaluated for potential investment and the relative position of the fund in the company or other fund asset may be negotiated and modified over time. Therefore, the total Reserve R in a fund may include a Pre-Invested Reserve (PIR) 1004, 1110, 1140 that shrinks as the fund becomes further invested. The fund's total Reserve R may also include an Overhead Reserve (OR) 1006, 1104, 1134, 1164 for overhead associated with the administration and management of the fund. Because the amount of money that an early stage company, or other fund asset for that matter, may require in order to fully realize its financial potential may be hard to determine in advance, it may be prudent to operate the fund with a total Reserve R that includes a Follow-up Reserve (FR) 1008, 1106, 1136, 1166. Additionally, if the fund is obligated to make debt payments prior to realization of sufficient cash flow from the fund's assets, then it may be necessary to establish a Bond Repayment Reserve (BRR) 1002, 1108, 1138, 1168 within the total Reserve R funded from the initial capital raised for the fund.

To better appreciate the function of the platform 101, the following series of computations are described. The total Reserve (R) 804, 904, 1000, 1100, 1130, 1160 required for the fund is equal to the sum of all necessary reserves, as shown in Equation 1.

$$R = P I R + O R + F R + B R R \qquad Equation 1 \text{-} Reserve$$

The Principal Invested in the Portfolio (PIP) 802, 1102, 1132, 1162, at any given point in time is also a function that may be modeled by simulation module 205 as the Capital Raised (CR) less Reserves, as shown in Equation 2.

$$P I P = CR - R \qquad Equation 2 \text{-} Capital Raised ( Simplified )$$

The PIP may be divided, by finance structure module 211, into Performing Assets (PA) 852, 902, 952 and Defaulted Assets (DA) 854, 906, 956, which can be determined by Equation 3 and which are shown in FIGS. 6A and 6B, respectively.

$$PA = P I P - D A \qquad Equation 3 \text{-} Performing Assets$$

The DA 854 may be determined as PIP 802 times the Default Rate (DR) 806, as shown in Equation 4 and FIG. 6A.

$$D A = P I P \times D R \qquad Equation 4 \text{-} Default Assets$$

The DR 806 may be projected for any time interval necessary in modeling the performance of the fund by simulation module 205, including annually or over the life of the fund as shown in FIG. 6B. However, the DR 806 alone may not be sufficient to calculate actual losses in principal for the fund, but should be modeled as a function of Recovery Value (RV), Exposure Value (EV) and the Cost of Recovery (COR). The loss on DA is a function of EV divided by RV less COR.

EV is similar to the ratio of the amount of the loan to the value of the asset against which the loan is made in the lending business (i.e. loan-to-value). In PE funds this is often a function of liquidated preferences and percentage of ownership in a company versus the liquidation value of the company. RV is the liquidated value of the company, and COR is the total cost associated with liquidating the company.

Thus, PA may be modeled as Equation 5.

$$Equation 5 \text{-} Modeling Performing Assets$$

$$PA = P I P - ( P I P \times DR ( EV / ( RV - COR ) )$$

Conservatively, EV/(RV−COR) may be simplified as “one” in terms of its numerical value, and therefore PA again equals PIP−DR as shown in Equation 3.

By modeling the above equations, the platform 101 determines a Return On Investment (ROI) for the Capital Raised (CR). In a simplified form, this may be modeled as shown in Equation 6.

$$Equation 6 \text{-} ROI for Capital Raised ( Simplified )$$

$$C {R}_{R O I} = P I {P}_{R O I} ( P I P / C R )$$

where CR_{ROI} is the Return On Investment on the Capital Raised, and PIP_{ROI} is the Return On Investment of the Principal Invested Portfolio.

This may be more fully modeled by platform 101 as follows, per Equation 7:

$$Equation 7 \text{-} R O I for Capital Raised ( Detailed )$$

$$C {R}_{R O I} = ( P I P - {( P I P \times DR ( EV / ( RV - COR ) ) )}_{R O I} ( P I P / C R )$$

Expanding on PIP, this may be modeled as shown in Equation 8.

$$Equation 8 \text{-} P I P ( Detailed )$$

$$C {R}_{ROI} = C R - PIR - OR - FR - BRR - {( ( C R - PIR - FR - BRR ) ( EV / ( RV - COR ) ) )}_{ROI} ( P I P / C R )$$

With the platform 101 modeling the above, the platform can then model the Return On Investment on the Equity Raised (EQ_{ROI}) as shown in Equation 9.

$$Equation 9 \text{-} R O I on Equity Raised$$

$$E {Q}_{R O I} = ( C {R}_{R O I} - C O D ) ( C R / PE Q )$$

where COD is the Cost Of Debt expressed in terms of a percentage, and PEQ is Principal amount of Equity in the fund as opposed to debt in the fund.

Consequently, the platform 101 advantageously outputs a pool financing structure that allows the increase in the rate of return to the subordinate class to be modeled when a senior class is included in the fund.

When multiple classes of debt are included in the fund, they may each have their own COD, which are expressed hereinafter as COD1, COD2, and so on. Therefore the effect of multiple classes of debt upon the rate of return to the equity class may be modeled, by the platform 101, as shown in Equation 10.

$$Equation 10 \text{-} E {Q}_{ROI} for Multiple Classes of Debt \\ E {Q}_{R O I} = ( C {R}_{ROI} - COD 1 ( D 1 / C R ) - COD 2 ( D 2 / C R ) … - CODn ( Dn / C R ) ) ( C R / C R - D 1 - D 2 … - Dn ) )$$

where D1, D2 and Dn are the principal amounts of each class of debt.

In one example where D1 and D2 represent two classes of debt in a fund, if CR_{ROI} is 20%, COD1 is 10%, D1 represents $50 Million, CR is $100 Million, COD2 is 12%, D2 represents $25 Million, then Equation 10 may be used to determine EQ_{ROI} as follows:

$$E {Q}_{ROI} = ( 0.2 - 0.1 ( 50 , 000 , 000 / 100 , 000 , 000 ) - 0.12 ( 25 , 000 , 000 / 100 , 000 , 000 ) ) \times ( 100 , 000 , 000 / ( 100 , 000 , 000 - 50 , 000 , 000 - 25 , 000 , 000 ) )$$

which gives:

$$E {Q}_{ROI} = ( 0.2 - 0.1 ( . 5 ) - 0.12 ( . 25 ) ) \times ( 100 / ( 100 - 50 - 25 ) )$$

which is:

$$E {Q}_{ROI} = ( 0.2 - 0.05 - .03 ) \times 4 = 48 \%$$

Therefore the effect of debt classes in this example takes a rate of return of 20% on the total capital raised and creates a rate of return of 48% on the equity raised.

The foregoing also applies to other equity situations where, instead of funds, it is debt instruments. Furthermore, for purposes of illustration, equity may include a subordinate class, and debt may include a senior class.

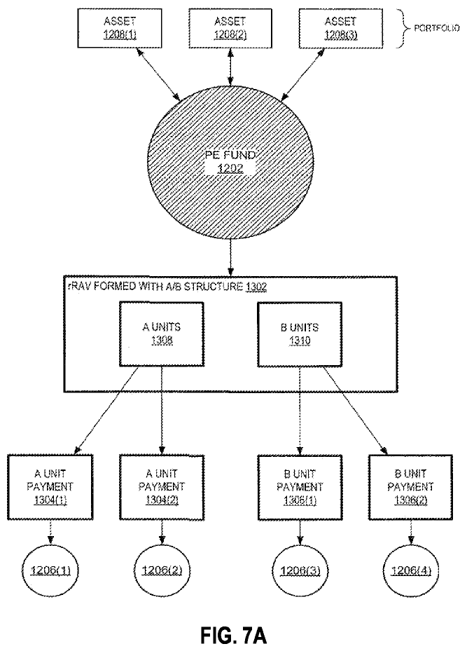

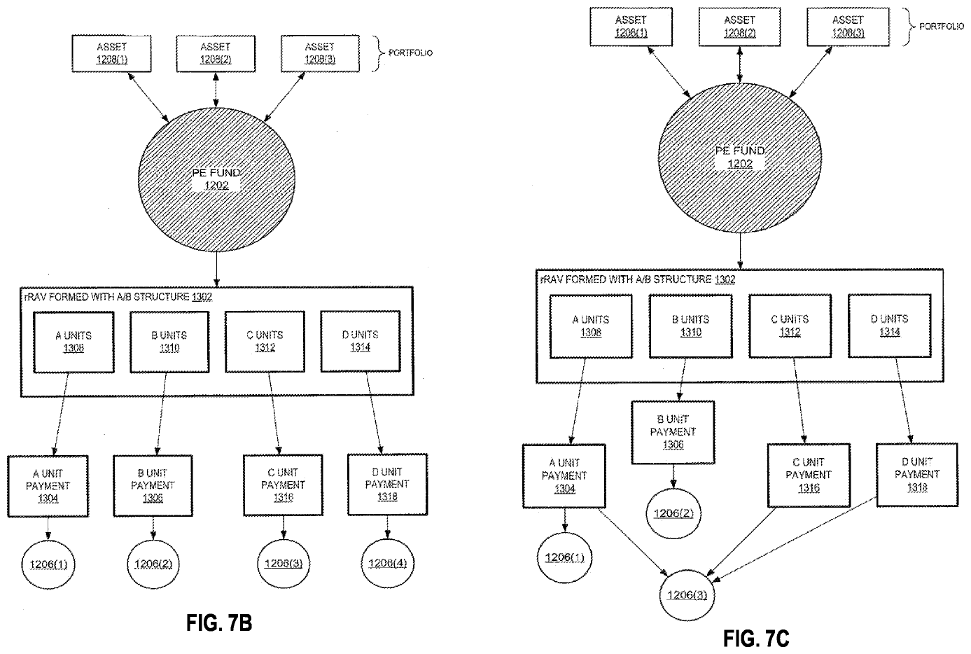

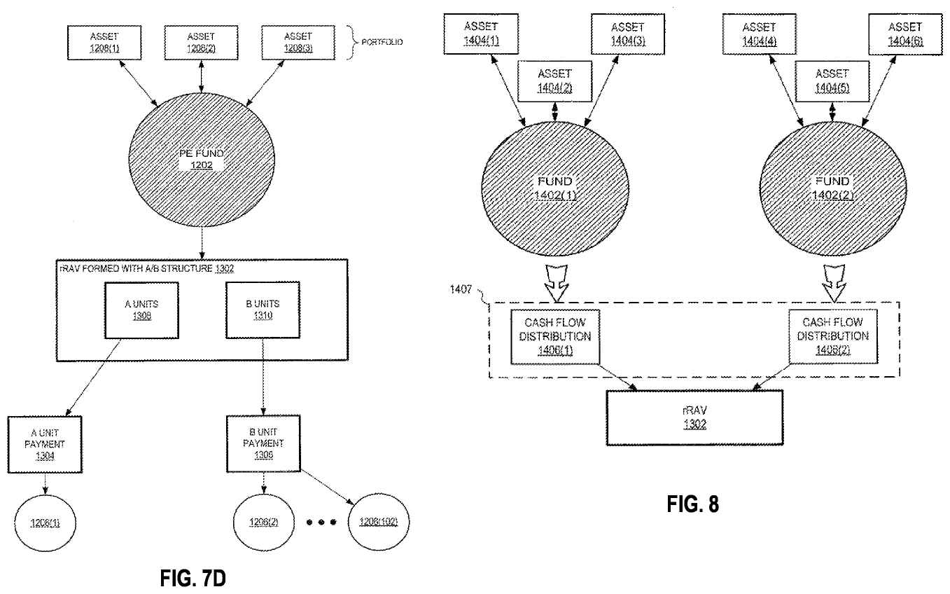

FIG. 7A shows an example of a risk/return allocation vehicle (rRAV) 1302 for structuring investment risk and cash flow distribution for LPs 1206(1)-(4). In the example of FIG. 7A, LPs 1206(1) and 1206(2) are willing to take a higher priority (i.e. faster) and more secure (i.e., less risky) return with a lower rate of return on their investments in PE fund 1202, whereas LPs 1206(3) and 1206(4) are willing to take a lower priority (i.e. slower) and less secure (i.e. more risky) return with a potentially higher rate of return on their investments in PE fund 1202. The platform 101 accounts for this distinction using, in part, the unit evaluation module 207.

In the example of FIG. 7A, rRAV 1302 is formed of two senior A units 1308 that receive a higher priority and more secure return, to which LPs 1206(1) and 1206(2) subscribe, and two junior B units 1310 that receive a lower priority and less secure return, to which LPs 1206(3) and 1206(4) subscribe. Senior A units 1308 are assigned, by the unit evaluation module 207, a fixed (i.e. capped) preferential return rate that is less than the anticipated total return rate for PE fund 1202, and junior B units 1310 are assigned an uncapped rate of return that is potentially higher than the total return rate for PE fund 1202.

In one embodiment, rRAV 1302 completes higher priority levels before making payments to the next highest priority level. As cash flow distributions are received by rRAV 1302 from PE fund 1202, the money is first distributed via A unit payments 1304(1) and 1304(2) to LPs 1206(1) and 1206(2), respectively, until the financial requirement of A units is met. The platform 101, in one embodiment, accounts for this using the cash flow allocation module 209. LPs 1206(3) and 1206(4) then receive the balance of all remaining cash flow distributions via B unit payments 1306(1) and 1306(2).

In another embodiment, the payment structure of each priority level of rRAV 1302 is defined by the unit evaluation module 207 such that the A units 1308 need not be fulfilled before a portion of the cash flow distributions is paid to the B units 1310. In one example of operation, rRAV 1302 allocates 100% of the cash flow distributions to A units 1308 until A units are 75% fulfilled and then allocates 75% of cash flow distributions to A units 1308 and 25% of cash flow distributions to B units 1310 until A units are 100% fulfilled, thereafter 100% of cash flow distributions are allocated to B units 1310. The percentage values in this example are illustrative and should not be considered limiting in any way. The percentages used may vary between 0% and 100% depending on the fund structure, as determined by the finance structure module 211.

Continuing with the example of FIG. 7A, assume each LP 1206(1)-(4) makes an equal $250M investment into PE fund 1202 (for a total investment of $1B) which is invested in assets 1208(1)-(3), and that over time, PE fund 1202 realizes a threefold return of $3B from assets 1208(1)-(3) for distribution to LPs 1206 via rRAV 1302. Under this scenario, unit evaluation module 207 assigns A units 1308 a preferential return rate of two times (2×) the principal investment amount of LPs 1206(1) and 1206(2). Thus, the first $1B of PE fund 1202's return is distributed via A unit payments 1304(1) and 1304(2) to LPs 1206(1) and 1206(2), respectively, for a total return of $500M for each LP. The remaining $2B of the return from PE fund 1202 is thereafter, as managed by cash flow allocation module 209, distributed via B unit payments 1306(1) and 1306(2) to LPs 1206(3) and 1206(4), respectively, for a total return of $1B for each LP (i.e., a total return rate of four times (4×) their principal investment amount).

FIG. 7B shows the platform 101 providing a rRAV 1302 that is configured with a plurality of priority levels (more than the senior A and junior B units of FIG. 7A), where cash flow distributions are prioritized based upon the priority level. In the example of FIG. 7B, rRAV 1302 has four priority levels A, B, C and D, shown as A units 1308, B units 1310, C units 1312, and D units 1314, respectively, where level A is the highest priority, level B is the second highest priority, level C is the third highest priority, and level D is the lowest priority, producing A unit payments 1304, B unit payments 1306, C unit payments 1316, and D unit payments 1318, respectively. Each of A units 1308, B units 1310, C units 1312, and D units 1314 may have an independently determined value, expected return, and associated risk, as determined by the unit evaluation module 207. As shown in FIG. 7C, one or more LPs may invest in more than one priority level of rRAV 1302. Under this example, LP 1206(1) has chosen to invest exclusively in A units 1308, LP 1206(2) has chosen to invest exclusively in B units 1310, whereas LP 1206(3) has chosen to split their overall investment in rRAV 1302 into between A units 1308, C units 1312, and D units 1314 (and not necessarily in equal percentages). By splitting investment between levels within rRAV 1302, an LP may customize their risk-return profile. The investment strategy information for the particular LPs can be specified as investment criteria (per investment criteria database 103) for the PE fund.

It should also be noted that rRAV 1302 may operate with any number of LPs 1206 invested in any of its priority levels. For example, as shown in FIG. 7D, only LP 1206(1) has invested in A units 1308 of rRAV 1302, whereas one hundred LPs 1206(2)-(101) have invested in B units 1310. It should further be noted that rRAV 1302 may operate without participation of all of the LPs in PE fund 1202, and does not affect the ongoing operation of PE fund 1202 or cash flow distributions to LPs that are not participating in rRAV 1302. For example, LPs 1206(2) and 1206(4) may choose to participate in rRAV 1302, while LPs 1206(1) and 1206(3) may choose to not participate and to preserve their original investment in PE fund 1202.

In one embodiment, the pool financing structure platform 101 generates a rRAV 1302 with multiple priority levels, whereby the cash flow distributions are allocated (via cash flow allocation module 209) proportionally to each priority level, such that each priority unit receives a portion of cash flow distributions. For example, rRAV 1302 may allocate 75% of the cash flow distributions to A units, with the remaining 25% being allocated to lower priority units, such that 75% of the 25% allocated to lower priority units is allocated to B units, and the remaining 25% of the 75% allocated to lower units, and so on. As each priority level is fulfilled, more of the cash flow distribution becomes allocated to the lower priority units.

In another embodiment, rRAV 1302 can be configured by platform 101 with multiple priority levels, wherein two or more of these levels receive a portion of the cash flow distribution of PE fund 1202 from the start of operation of rRAV 1302. Using the example of FIG. 7B, A units 1308 may receive 50% of cash flow distributions from PE fund 1202, B units 1310 may receive 30% of the cash flow distributions, C units 1312 may receive 15% of the cash flow distributions, and D units 1314 may receive 5% of the cash flow distributions. As each level is fulfilled, the percentage allocation of the cash flow distributions is adjusted so that 100% of the cash flow distribution from PE fund 1202 is allocated, for example proportionally, to the remaining unfulfilled levels. Thus, LPs investing at any one or more levels receive a portion of the cash flow distributions at the earliest opportunity, and these distributions are proportionate to the level within rRAV 1302, and are tracked by, e.g., investor allocation database 107.

The platform 101 may apply rRAV 1302 to either a new PE fund or may be applied to restructure an existing PE fund. Specifically, the use of rRAV 1302 when structuring a new PE fund may allow previously uninterested investors to become LPs in the fund. Because the level of risk/return varies depending upon the relative seniority of each level (e.g., A units 1308, B units 1310, C units 1312, and D units 1314) within rRAV 1302, rRAV 1302 may be used to create a variety of risk/return profiles that may appeal to a broader range of potential investors. The use of rRAV 1302 may also allow GPs to include a wider variety of assets within a fund. For example, assets with a shorter term, lower risk/lower return profile may be included in rRAV 1302 because such assets may provide cash flow distributions that satisfy higher levels within rRAV 1302 (e.g., that provide payment to senior LPs' receiving preferential cash flow distributions) without diluting the distribution to the subordinate classes within rRAV 1302, whereas inclusion of such assets in conventional funds having a conventional single-tiered structure may not be feasible because of their dilutive effect on overall fund rate of returns. Likewise, GPs may include longer term, higher risk/higher return assets in rRAV 1302 without negatively impacting the time-to-maturity or risk/return profile of senior classes within rRAV 1302.

Units (e.g., units 1308, 1310, 1312, and 1314) in rRAV 1302 may be derived from a portfolio of multiple PE funds, or even from multiple rRAVs. FIG. 8 shows an example of two funds 1402(1) and 1402(2) having cash flow distributions 1406(1) and 1406(2), respectively, which feed into rRAV 1302.

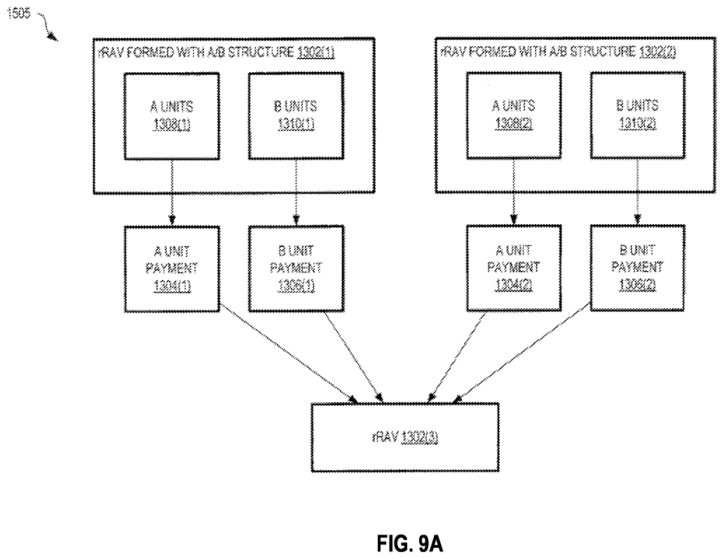

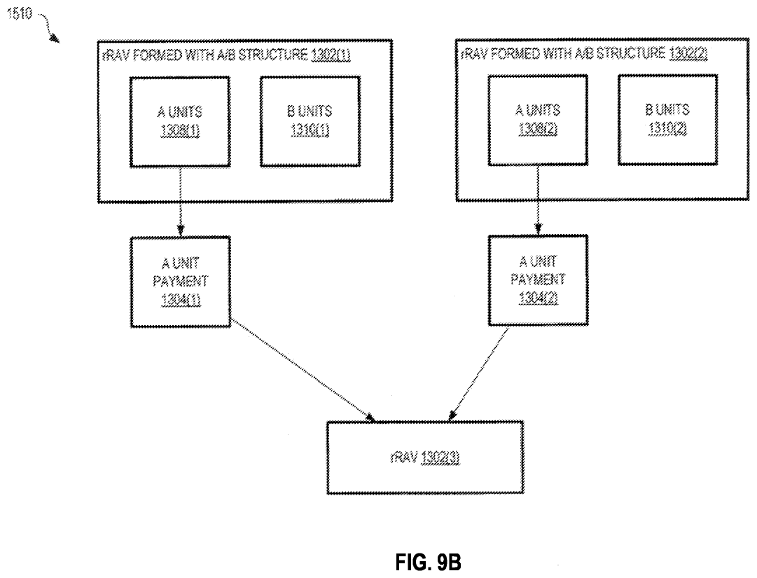

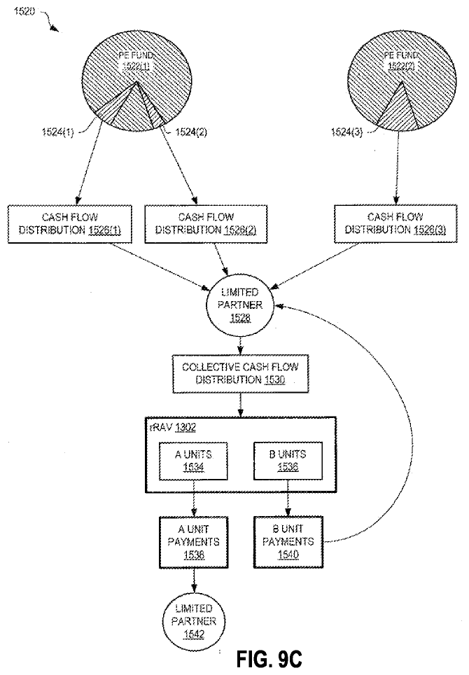

FIG. 9A shows two rRAVs 1302(1) and 1302(2) each having A units 1308(1), 1308(2) and B units 1310(1), 1310(2), respectively, wherein cash flow distribution, shows as A unit payments 1304(1)-(2) and B unit payments 1306(1)-(2), respectively, is fed into a third rRAV 1302(3). The examples shown in FIG. 9A may provide increased diversity from the underlying collateral risk. As in the case with a rRAV based upon a single PE fund, rRAV 1302 with a portfolio of interests in multiple PE funds and/or other rRAVs may specify certain assets within its underlying portfolio from which its various classes (e.g., units 1308, 1310, 1312, and 1314) may receive cash flow distributions. FIG. 9B shows rRAV 1302(3) formed exclusively from the A units 1308 of rRAVs 1302(1) and 1302(2).

An investor (e.g., individual or institutional) that has an investment portfolio of one or more LP units issued by one or more PE funds may assign the cash flow distributions of any combination of the LP units to an rRAV that they may create and own. Such actions may be initiated through investment application 119 (shown in FIG. 1). The investor may then sell some or all units of this rRAV, thereby gaining liquidity and/or optimizing their risk-return profile. The platform 101 can account for these transactions and risk-return profile information with the investor allocation database 107, for example.

FIG. 9C shows an example of an investment scenario 1520 wherein LP 1528 receives cash flow distributions 1526(1)-(2) from LP units 1524(1) and (2) in PE fund 1522(1) and receives cash flow distribution 1526(3) from LP unit 1524(3) in PE fund 1522(2). LP 1528 thus has three LP units 1524 and receives three cash flow distributions 1526. LP 1528 assigns the collective cash flow distributions 1526 from LP units 1524 to rRAV 1302 configured with A units 1534 and B units 1536 that generate A unit payments 1538 and B unit payments 1540, respectively. The investor sells A units 1534 to an LP 1542 who receives A unit payments 1538 and retains B units and thus receives B unit payments 1540.

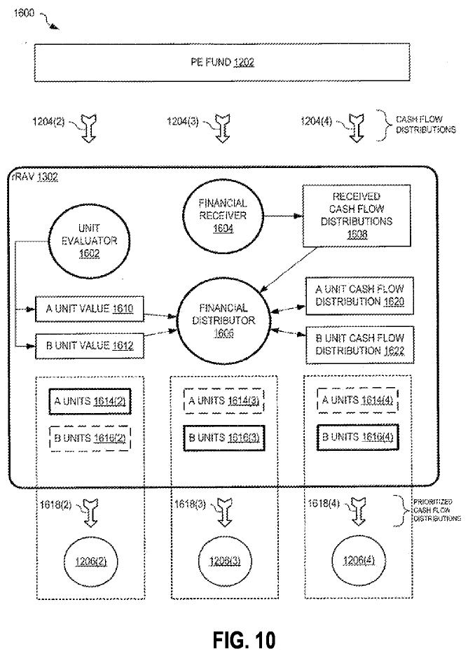

FIG. 10 shows an example of a system 1600 for implementing rRAV 1302 of FIGS. 7A-7D. It is noted that the system 1600 can be readily implemented by platform 101, or can be a variation of platform 101. In the embodiment shown, rRAV 1302 is denoted as a computing system for ease of reference; and the system includes various hardware and/or software components to implement the following: a unit evaluator 1602, a financial receiver 1604 and a financial distributor 1606. Unit evaluator 1602, financial receiver 1604, and financial distributor 1606 are for example implemented as machine readable instructions stored within a memory of a computer and executed by a processor to provide the disclosed functionality of rRAV 1302. In the example of FIG. 10, financial receiver 1604 receives cash flow distributions 1204(2), 1204(3), and 1204(4) of LPs 1206(2), 1206(3) and 1206(4), respectively, from PE fund 1202, and tracks this cash flow as received cash flow distributions 1608. As previously noted, PE fund 1202 may represent one or more funds that provide cash flow distributions to LPs 1206. Unit evaluator 1602 determines an A unit value 1610 and a B unit value 1612 based upon pledged cash flow distributions 1204(2)-(4), allocated A units 1614, allocated B units 1616, and estimated prioritized cash flow distributions 1618(2)-(4).

Financial distributor 1606 distributes received cash flow distributions 1608 to LPs 1206(2)-(4) based upon A unit value 1610, B unit value 1612, the number of A units 1614 and B units 1616 held by each LP, and an accumulated A unit cash flow distribution 1620. Financial distributor 1606 accumulates payment values made to each A unit 1614 within A unit cash flow distribution 1620, and optionally accumulates payment values made to each B unit within B unit cash flow distribution 1622.

Each LP 1206(2)-(4) is allocated zero or more A units 1614 and zero or more B units 1616 based upon an agreed prioritized cash flow distribution 1618. That is, based upon the risk and return goals of the LP, A units and/or B units are allocated to the LPs based upon the cash flow distributions of that LP relative to the cash flow distributions of the other LPs. rRAV 1302 requires at least two LPs that have differing prioritized cash flow distributions 1618.

Continuing with the example of FIG. 10, in one example of operation of system 1600, unit evaluator 1602 allocates one A unit 1614(2) to LP 1206(2) based upon cash flow distribution 1204(2) of $50M/Y and a desired reduced risk prioritized cash flow distribution 1618(2) of $30M/Y. In this example, the value of A unit 1614(2) is $30M. Unit evaluator 1602 allocates B units 1616(3)-(4) to LPs 1206(3)-(4) based upon cash flow distributions 1204(3)-(4), and their agreement for receiving lower priority cash flow distributions 1618(3)-(4), respectively. Thus, based upon the expected received cash flow distributions of $150M and the A unit value of $30M, the cash flow distribution for each B unit 1616(3) and 1616(4) is estimated at $60M.

Financial receiver 1604 accumulates cash flow distribution 1204 from PE fund 1202 within received cash flow distributions 1608. Financial distributor 1606 first utilizes received cash flow distributions 1608 to fulfill A units 1614. That is, in this example, financial distributor 1606 allocates the first $30M of received cash flow distributions 1608 to A unit 1614(2) as prioritized cash flow distribution 1618(2) to LP 1206(2), and then pays any remaining received cash flow distributions to B units 1616(3) and 1616(4) as prioritized cash flow distributions 1618(3) and 1619(4) to LPs 1206(3) and 1206(4), respectively. Specifically, financial distributor 1606 accumulates the value of A unit payments within A unit cash flow distribution 1620 such that it may determine when A units 1614 are fulfilled. If, for example, PE fund 1202 distributed $12.5M each month as cash flow for cash flow distributions 1204(2)-(4), after the third month, A unit 1614(2) would be fulfilled and the remaining cash flow of $7.5M for that third month would be distributed evenly between B units 1616(3) and 1616(4). For the remaining months of the year, A unit 1614(2) would receive no further money, and all following cash flows would be distributed evenly to B units 1616(3) and 1616(4).

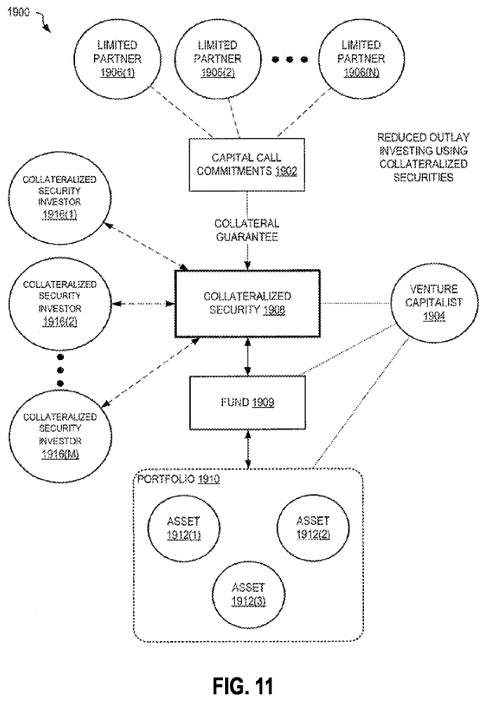

To further enhance the viability of a private equity fund, the platform 101 (of FIG. 1) may, as mentioned above, utilize Reduced Outlay Investing (RoI) to create and operate an investment fund. FIG. 11 shows an RoI example where capital call commitments of one or more LPs are used as a collateral guarantee to issue a collateralized security to raise capital for a fund. The equity within PE fund is contributed by LPs when ‘called’ by the PE fund's GPs from capital call commitments made by LPs. Limited partners collectively provide capital call commitment for PE fund. It is noted that, in general, only a certain percentage of the total capital commitment is actually called upon (typically around 70%) for fund equity. PE funds often choose to retain a portion of the uncalled capital for follow-on investments, bolt-on acquisitions, emergency injections of capital, operational purposes, and to fund debt service. The actual rate of return on investment for each LP in the PE fund is a ratio based upon the amount of capital actually called upon from the LP versus the total cash flow distribution received by the LP.

The credit worthiness of each LP in a PE fund is relied upon in terms of their ability to fulfill the capital call, based upon their capital commitment, to fund the PE fund. Rather than calling upon their LPs for capital, however, the GPs of a PE fund may obtain financing against the capital commitment obligations of their LPs. The ability to issue securities, whether rated or unrated, against the PE fund's capital call obligations may depend upon a combination of factors, as shown in Table 1.

TABLE 1
Security Issue Related Factors

The credit worthiness of each LP and/or security pledged by the LP to
guarantee their capital commitment.
The terms and conditions of the capital commitment, especially with
regard to its enforceability under all probable future scenarios.
The percentage of the capital commitment being borrowed against in
terms of principal amount of the collateralized securities and their
associated schedule of interest payments due.
The fund's investment guidelines, not only in terms of the nature of the
assets, but in terms of the percentage of the total call amount available
that will be invested in the assets versus held for future debt service.
The controls in place to ensure compliance with the terms and
conditions referenced above (e.g., the use of trustees and servicing
agents).

The above factors are captured as data and rules that analyzed and executed by ROI module 217, when the ROI mechanism is invoked by the pool financing structure platform 101.

The net effect of financing the PE fund using securities collateralized against capital commitments to the fund, is to extend the leveraging effect of financing the fund; the LPs achieve a higher cash-on-cash return against the dollar amount called upon if the fund employs such financing compared to the rate of return achieved if the fund calls upon its capital commitments, provided that the fund's assets generate a rate of return in excess of the cost of the rated securities issued.

Financing a PE fund against capital commitments is, in most circumstances, more straight-forward than financing the PE fund against the value of its assets, especially since the value of the assets can only be established over time once the initial investment has been made.

In one embodiment, shown in FIG. 11, RoI is realized through capital call commitments 1902 of one or more LPs 1906 that are used as a collateral guarantee to issue collateralized securities 1908 (as monitored and managed by collateralized security module 210) to raise capital for a fund 1909. Depending on the value of the collateral, an investment grade rating may or may not result for some or all of the collateralized securities; this rating determination is conducted with the assistance of the rating module 213.

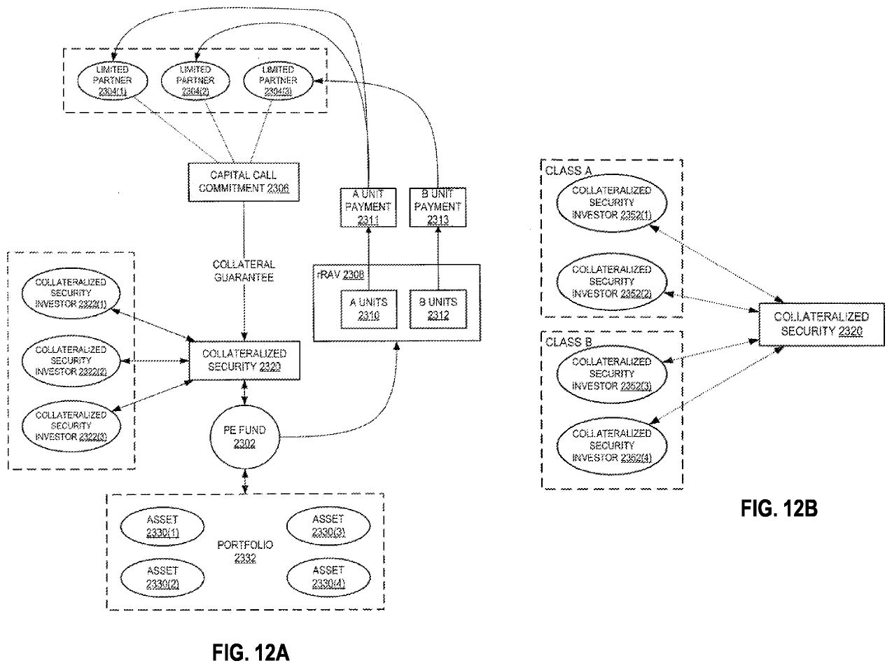

FIG. 12A shows an example of a combined use of an rRAV 2308 and ROI (implemented through a collateralized security 2320) with a PE fund 2302. In the example of FIG. 12A, the platform 101 produces a rRAV 2308 that is configured with two senior A units 2310, to which LPs 2304(1) and 2304(2) subscribe, and one junior B unit 2312, to which LP 2304(3) subscribes. Capital call commitments 2306 from LPs 2304 are used as a collateral guarantee to issue one (or more) collateralized security 2320 that is sold to collateralized security investors 2322(1), (2) and (3). The capital raised from the sale of collateralized security 2320 is used to finance PE fund 2302 and the money is invested in a portfolio 2332, shown with three assets 2330(1), (2), and (3), for example.

Cash flow distributions, as performed via cash flow allocation module 209, from PE fund 2302 are first paid to collateralized security investors 2322 until collateralized security 2320 has been fully repaid. The remaining cash flow distributions from PE fund 2302 are paid to rRAV 2308, from where it is first distributed via A unit payments 2311 to LPs 2304(1) and (2) until the financial requirement of A units 2310 is met. LP 2304(3) then receives the balance of all remaining cash flow distributions via B unit payments 2313.

Combining both rRAV 1302 of FIG. 7A and RoI of FIG. 11 may generate additional benefits for a PE fund as compared to benefits of using only the rRAV. For example, combining rRAV 1302 and RoI collateralized security 1908 may allow the cost of funds to be reduced below a cost level that the fund may have achieved through the use of the rRAV or RoI alone. For example, if a PE fund employs RoI, using its capital call commitments as collateral to raise capital for acquiring assets, a GP of the PE fund may be able to negotiate a lower rate of return to the providers of the capital call commitments in the event that their commitment is never called upon, than the rate of return that they would have to pay in the event that their commitment is called upon. By using both rRAV and RoI, rates of return for both scenarios may be negotiable to an even lower level by establishing a senior class of capital call commitments that are called only after the subordinate class, or classes, of commitments are called.

FIG. 12B shows collateralized security 2320 of FIG. 12A structured into senior (A) and subordinate (B) classes, similar to the unit levels described in rRAV 1302. In the example of FIG. 12B, collateralized security investors 2352(1) and (2) invest in a senior class of collateralized security 2320, and collateralized security investors 2352(3) and (4) invest in a subordinate class of collateralized security 2320.

The processes described herein for providing creating a pool financing structure based on data analysis of investment data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

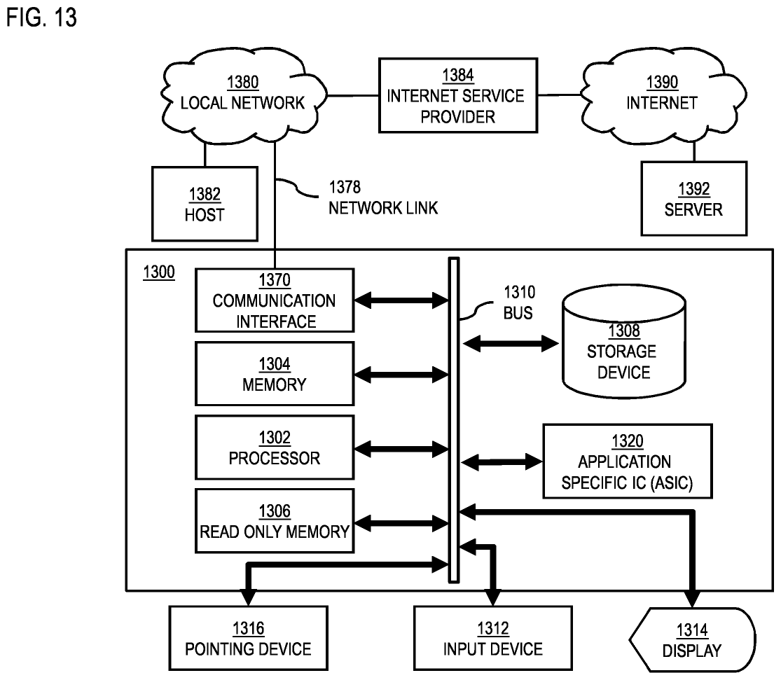

FIG. 13 illustrates a computer system 1300 upon which an embodiment of the invention may be implemented. Computer system 1300 is programmed (e.g., via computer program code or instructions) to create a pool financing structure and to optionally employ a reduced outlay investing mechanism as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1310 includes one or more parallel conductors of information so that information is transferred quickly among devices coupled to the bus 1310. One or more processors 1302 for processing information are coupled with the bus 1310.

A processor 1302 performs a set of operations on information as specified by computer program code related to create a pool financing structure as well as employ a reduced outlay investing mechanism. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1300 also includes a memory 1304 coupled to bus 1310. The memory 1304, such as a random access memory (RAM) or other dynamic storage device, stores information including processor instructions for creating a pool financing structure and/or utilizing a reduced outlay investing mechanism. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for creating a pool financing structure and/or utilizing a reduced outlay investing mechanism is provided to the bus 1310 for use by the processor from an external input device 1312, such as a keyboard containing alphanumeric keys operated by a human user, a sensor, a microphone, an Infrared (IR) remote control, a joystick, a game pad, a stylus pen, or a touch screen. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a vacuum fluorescent display (VFD), a liquid crystal display (LCD), a light-emitting diode (LED), an organic light-emitting diode (OLED), a quantum dot display, a virtual reality (VR) headset, or plasma screen or printer for presenting text or images, and a pointing device 1316, such as a mouse, a trackball, cursor direction keys, or motion sensor, for controlling a position of a small cursor image presented on the display 1314 and issuing commands associated with graphical elements presented on the display 1314. In some embodiments, for example, in embodiments in which the computer system 1300 performs all functions automatically without human input, one or more of external input device 1312, display device 1314 and pointing device 1316 is omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 109 for creating a pool financing structure and/or utilizing a reduced outlay investing mechanism to the UE 117.

The term computer-readable medium is used herein to refer to any medium that participates in providing information to processor 1302, including instructions for execution. Such a medium may take many forms, including, but not limited to, non-volatile media, volatile media and transmission media. Non-volatile media include, for example, optical or magnetic disks, such as storage device 1308. Volatile media include, for example, dynamic memory 1304. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, EEPROM, a flash memory, any other memory chip or cartridge, a carrier wave, or any other medium from which a computer can read.

FIG. 14 illustrates a chip set 1400 upon which an embodiment of the invention may be implemented. Chip set 1400 is programmed to create a pool financing structure and/or utilize a reduced outlay investing mechanism as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to create a pool financing structure and/or utilize a reduced outlay investing mechanism. The memory 1405 also stores the data associated with or generated by the execution of the inventive steps.

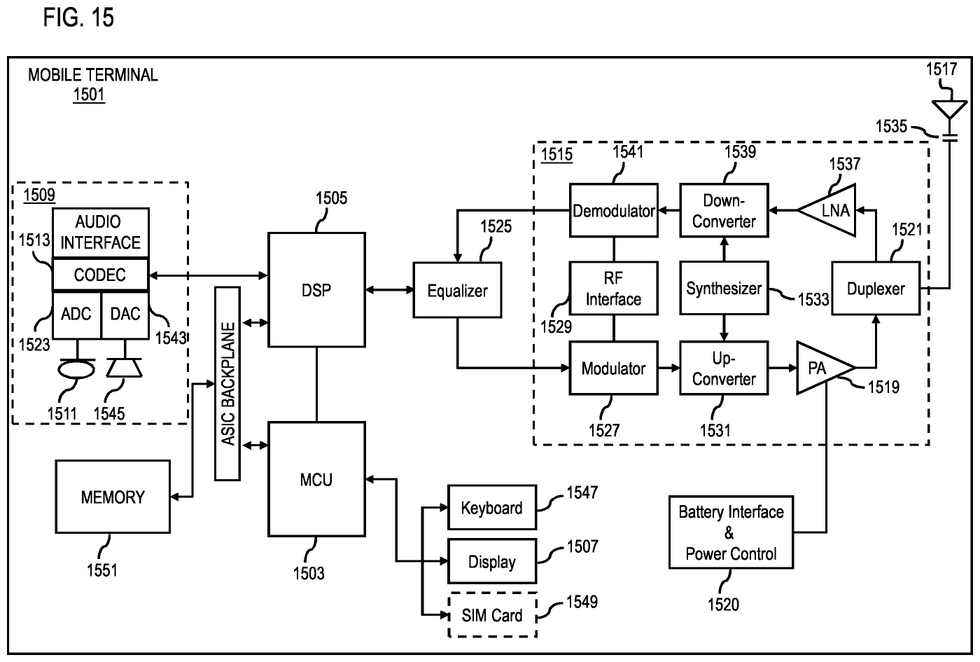

FIG. 15 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile station functions that offer automatic contact matching. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile station 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503—which can be implemented as a Central Processing Unit (CPU) (not shown).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile station 1501 to create a pool financing structure and/or utilize a reduced outlay investing mechanism. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the station. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile station 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1551 may be, but not limited to, a single memory, CD, DVD, ROM, RAM, EEPROM, optical storage, or any other non-volatile or non-transitory storage medium capable of storing digital data.

An optionally incorporated SIM card 1549 carries, for instance, important information, such as the cellular phone number, the carrier supplying service, subscription details, and security information. The SIM card 1549 serves primarily to identify the mobile station 1501 on a radio network. The card 1549 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A pool financing software system, comprising:
a memory; and
a processor operatively coupled with the memory, wherein the processor is configured to execute program code that includes:
a simulation module configured to operatively receive a plurality of external economic condition parameters from a system database and a plurality of investment parameters from an investment criteria database, wherein the plurality of external economic condition parameters are processed to dynamically simulate private equity portfolio performance over time, according to the plurality of investment parameters, to generate a simulation output, wherein the simulation output includes a plurality of collateralized securities data;
an investment selection module in operative communication with the simulation module, wherein the investment selection module processes the simulation output in conjunction with the plurality of investment parameters from the investment criteria database to flag one or more investment vehicles for use by a new investment fund, with the flagged one or more investment vehicles stored in the system database;
an allocation module configured to process the flagged one or more investment vehicles from the system database, in conjunction with the plurality of economic condition parameters, to compute a yield value representing future cash flow data and to create a plurality of prioritized units for the new investment fund;
a finance structure module configured to process the simulation output from the simulation module, in conjunction with the created plurality of prioritized units, to automatically create an optimal financing unit structure for the new investment fund; and
a unit evaluation module configured to process at least the optimal financing unit structure to determine whether the optimal financing unit structure satisfies a plurality of fund objectives data from a fund objectives database, and outputting a complete structure of the new investment fund if the plurality of fund objectives data is satisfied.

2. The system of claim 1, further including a reduced outlay investing module configured to permit financing against committed investor capital.

3. The system of claim 2, wherein the reduced outlay investing module includes matching one or more of the created plurality of prioritized units with one or more proposed bonds.

4. The system of claim 1, wherein each of the created plurality of prioritized units is different from one another.

5. The system of claim 1, wherein the created plurality of prioritized units are associated with a plurality of different rates of return.

6. The system of claim 1, wherein the created plurality of prioritized units are associated with one or more of the following: a plurality of rates of return, a plurality of risk tolerances, and a plurality of maturities.

7. The system of claim 1, further including a report module configured to generate a distribution report including data associated with a rate of return for the created plurality of prioritized units.

8. The system of claim 1, wherein the external economic condition parameters include actuarial data.

9. The system of claim 1, wherein the plurality of collateralized securities data are associated with one or more collateralized securities investors.

10. The system of claim 1, wherein the finance structure module is further configured to modify the optimal financing unit structure for the new investment fund over time.

11. A method of a pool financing software system, comprising:
executing a simulation module configured to operatively receive a plurality of external economic condition parameters from a system database and a plurality of investment parameters from an investment criteria database, wherein the plurality of external economic condition parameters are processed to dynamically simulate private equity portfolio performance over time, according to the plurality of investment parameters, to generate a simulation output, wherein the simulation output includes a plurality of collateralized securities data;
executing an investment selection module in operative communication with the simulation module, wherein the investment selection module processes the simulation output in conjunction with the plurality of investment parameters from the investment criteria database to flag one or more investment vehicles for use by a new investment fund, with the flagged one or more investment vehicles stored in the system database;
executing an allocation module configured to process the flagged one or more investment vehicles from the system database, in conjunction with the plurality of economic condition parameters, to compute a yield value representing future cash flow data and to create a plurality of prioritized units for the new investment fund;
executing a finance structure module configured to process the simulation output from the simulation module, in conjunction with the created plurality of prioritized units, to automatically create an optimal financing unit structure for the new investment fund; and
executing a unit evaluation module configured to process at least the optimal financing unit structure to determine whether the optimal financing unit structure satisfies a plurality of fund objectives data from a fund objectives database, and outputting a complete structure of the new investment fund if the plurality of fund objectives data is satisfied.

12. The method of claim 11, further including executing a reduced outlay investing module configured to permit financing against committed investor capital.

13. The method of claim 12, wherein the reduced outlay investing module includes matching one or more of the created plurality of prioritized units with one or more proposed bonds.

14. The method of claim 11, wherein each of the created plurality of prioritized units is different from one another.

15. The method of claim 11, wherein the created plurality of prioritized units are associated with a plurality of different rates of return.

16. The method of claim 11, wherein the created plurality of prioritized units are associated with one or more of the following: a plurality of rates of return, a plurality of risk tolerances, and a plurality of maturities.

17. The method of claim 11, further including executing a report module configured to generate a distribution report including data associated with a rate of return for the created plurality of prioritized units.

18. The method of claim 11, wherein the external economic condition parameters include actuarial data.

19. The method of claim 11, wherein the plurality of collateralized securities data are associated with one or more collateralized securities investors.

20. The method of claim 11, wherein the finance structure module is further configured to modify the optimal financing unit structure for the new investment fund over time.
